(19) United States
(12) Patent Application Publication
(10) Pub. No.: US 2008/0160474 A1
(43) Pub. Date: Jul. 3, 2008

(54) Orthodontic Bracket With Lined Archwire Slot and Slot Cover

(75) Inventors: David Wolf, Lakewood, CO (US); Tony Zakhem, Highlands Ranch, CO (US); Leon Laub, Fort Collins, CO (US); Michael Stevens, Littleton, CO (US); George Kantor, Denver, CO (US)

Correspondence Address: SHERIDAN ROSS PC, 1560 BROADWAY, SUITE 1200, DENVER, CO, 80202, US

(73) Assignee: RMO, INC., Denver, CO (US)

(21) Appl. No.: 11/695,555

(22) Filed: Apr. 2, 2007

Related U.S. Application Data
(60) Provisional application No. 60/788,267, filed on Mar. 31, 2006.

(51) Int. Cl. A61C 7/14; A61C 7/28

(52) U.S. Cl. 433/10

(57) ABSTRACT

A triple wing orthodontic bracket, bracket cover, and method of use is disclosed. The bracket has a slot liner for reducing friction between an archwire and the bracket, wherein the liner is flared at its ends. The bracket cover has: a rod-shaped hinge for rotating in recesses between a bracket base, and bracket wings on one of a gingival and occlusal bracket side, a slot cover, and a cross member for rotating the slot cover between covering a bracket archwire slot, and uncovering the slot, wherein the rotation pivots the hinge in the recesses. The hinge and recesses frictionally engage one another, wherein in a first position, the hinge attaches and detaches from the bracket, and after pivoting the hinge to another position in the recesses, the hinge is secured therein. Interaction between the hinge and the recesses may cause the slot cover to move to cover the slot.

### CROSS REFERENCE TO RELATED APPLICATION

The present application claims the benefit of U.S. Provisional Patent Application No. 60/788,267 filed on Mar. 31, 2006, and entitled “ORTHODONTIC BRACKET WITH LINED ARCHWIRE SLOT”, the entire content of which is incorporated herein by reference in its entirety.

### FIELD

The present invention relates to an orthodontic bracket, a bracket cover therefor, and a method of use of the bracket and cover. The bracket includes a liner for reducing friction with an archwire, and an archwire slot/channel in the bracket. The bracket cover is for covering the archwire slot in the bracket, wherein the bracket cover attaches and detaches from the bracket, and when attached can be rotated between a position for covering the archwire slot/channel, and a position for uncovering the archwire slot/channel.

### BACKGROUND

In orthodontic treatment, tiny devices known as brackets are secured to the patient's teeth. An archwire is received in a slot of each bracket, and is typically held in place in the slots by ligating wires or by small elastic O-rings that extend around each bracket and the archwire. The teeth, to which the brackets are attached, are urged toward orthodontically correct positions by bends or twists placed in the archwire, and/or by elastomeric bands interconnecting the brackets. One or more archwires each serves as a track to guide sliding movement of the brackets so that the teeth to which they are attached may be shifted toward desired positions.

In the past, orthodontic brackets were often made of stainless steel, and archwires were made of stainless steel or alloys containing stainless steel, nickel and titanium. In general, frictional resistance to sliding movement of the metal brackets has not been a factor considered overly important by most orthodontists since the metal on metal sliding coefficient of friction is not high enough to typically be of concern. However, metal brackets are not aesthetic, and accordingly alternative materials have been used for such brackets such as plastics and ceramics of various types that are non-opaque or translucent.

Orthodontic brackets made of non-opaque plastic materials such as polycarbonate have been introduced by various manufacturers. Unfortunately, some plastic brackets exhibit undue deformation of the archwire slots as orthodontic forces are applied by the archwire to the brackets. Undue deformation of the archwire slots may prevent precise control of movement of the associated teeth, and in some instances may cause the brackets to fracture. Replacement of brackets during orthodontic treatment is time consuming and is often considered a nuisance by the orthodontist as well as by the patient.

It has been proposed in the past to provide metallic archwire slot liners for plastic brackets, in part as an attempt to avoid deformation of the plastic material. Examples of archwire slot liners are described in U.S. Pat. Nos. 3,964,165, 4,299,569, 4,302,532, 6,264,469 and 6,913,459, each of these references being incorporated fully herein by reference. Metallic archwire slot liners for plastic brackets provide sliding mechanics that may resemble the sliding mechanics experienced when an all-metal bracket is used.

Orthodontic brackets have also been made of translucent ceramic material such as polycrystalline aluminum oxide as is described in U.S. Pat. No. 4,954,080, also fully incorporated herein by reference. Ceramic is a relatively hard material in comparison to plastic and does not exhibit creep deformation in areas adjacent the archwire slot when subjected to forces of the archwire. However, application of an undue force by the archwire may fracture the bracket, possibly because of localized areas of relatively high stress concentrations.

As a further drawback to ceramic, the sliding mechanics of a metallic archwire in a slot of a ceramic bracket are not as satisfactory; i.e., the coefficient of friction is high and can cause binding of the archwire in the bracket. In particular, undue resistance of a ceramic bracket to sliding movement along an archwire may lengthen treatment time and thus provide an additional expense to both the orthodontist and the patient. This type of friction is referred to herein as “binding friction”. Some attempts have been made to address the problem of binding friction.

Additionally, difficulties exist in providing a bracket that serves both early and late stages of treatment, as well as treatment between these stages. These problems are due to the desired amount of tooth alignment force exerted by the archwire on the bracket slot at different periods of treatment, wherein such an alignment force may be generally traverse to the length of the archwire. Typically, a minimal amount of alignment force is desired for moving a bracket (and its tooth) in a desired direction relative to an archwire during the early phase of treatment. In contrast, typically a greater amount of alignment force is desired between a bracket and an archwire in the later phase(s) of treatment. Accordingly, it would be advantageous to provide an orthodontic bracket that provides an orthodontist the ability to vary the alignment force during the various phases of treatment. Moreover, there is still a need for a bracket and method of application that offers a range of alignment forces, while reducing the problems associated with binding friction.

To provide further background regarding the present disclosure, the following U.S. patents are also incorporated herein by reference in their entirety: U.S. Pat. Nos. 6,264,469 “Orthodontic Component, in Particular a Bracket with an Insert Element”; U.S. Pat. No. 5,441,408 “Orthodontic Device with a Ceramic Tooth Attachment”; U.S. Pat. No. D358,650 “Orthodontic Device Having a Ceramic Tooth Attachment”; U.S. Pat. No. D358,649 “Orthodontic Device Having a Ceramic Tooth Attachment”; U.S. Pat. No. 5,299,934 “Teeth Straightening Bracket”; U.S. Pat. No. 5,653,588 “Plastic Orthodontic Component Part and Method of Forming”; U.S. Pat. No. 5,254,002 “Orthodontic Plastic Bracket”; U.S. Pat. No. 5,362,232 “Orthodontic Appliance Mounting Base”; U.S. Pat. No. 5,470,228 “Edgewise Orthodontic Bracket”; U.S. Pat. No. 5,707,231 “Orthodontic Assembly with Reinforcement Structure”; U.S. Pat. No. 6,478,579 “Orthodontic Twin Bracket with Archwire Floor and Side Wall Relief”; and U.S. Pat. No. 6,846,178 “Orthodontic Bracket Base Apparatus and Method of Manufacture”.

### SUMMARY

An orthodontic bracket and method of use is disclosed herein that substantially reduces the archwire binding friction particularly prevalent in an initial stage(s) of orthodontic treatment wherein a patient's teeth may be exceptionally misaligned, and wherein substantial movement of the teeth is desired. The novel bracket disclosed herein preferably has a triple wing configuration (i.e., having mesial and distal tie wings extending gingivally and occlusally with a center tie wing between each pair mesial and distal tie wings) with a slot liner that reduces the binding friction between the bracket and archwire. The novel bracket the triple wing configuration provides for substantial variation in ligature orientations on the bracket for varying the tension that can be applied to hold an archwire in the bracket slot, wherein at least one such orientation provides appreciably less tension than is typically available with a twin wing or other bracket configurations. Accordingly, there is an appreciable reduction in binding friction. Moreover, since the novel bracket further includes a reduced friction liner in the bracket slot, wherein the liner (and possibly the slot as well) is flared at its mesial and distal ends (i.e., the archwire channel in the bracket expands at its ends) the, an even greater reduction in binding friction is obtained. In fact, the combination of the above recited features of the novel bracket provides for a reduction in binding friction reduction of at least approximately 5 times over brackets that do not have one or more of the above-recited bracket features. Accordingly, the novel bracket and method of use results in better tooth rotational control than heretofore has been available. Additionally, note that the expanded channel mesial and distal ends provide for enhanced ease of archwire insertion.

In one embodiment, the novel bracket may have a bracket body that is translucent or non-opaque with a low friction liner of gold liner.

In one embodiment, a midsection of the liner (of, e.g., at least ¼ to ⅘ of the liner length, and more preferably ½ to ⅘ of the liner length) provides straight effectively parallel sidewalls, thereby providing additional tooth rotational control.

In at least one embodiment the liner (and possibly the slot as well) may have a liner floor or base between the liner sidewalls that also expands the cross section of the channel as the cross section is taken closer to the mesial end of the channel, or closer to the distal end of the channel. In particular, the liner base or floor may flare out at its mesial and distal ends approximately 20 to 30% of the shortest height of the liner (i.e., channel) sidewalls. Moreover, such embodiments may additionally include a substantially planar or flat channel base or floor midsection for also enhancing tooth rotational control. In particular, a midsection of at least 25% of the channel's length may be planar or flat, and preferably between 50% and 80%.

Embodiments of the novel brackets disclosed herein may be central, lateral, cuspid, and bicuspid brackets as one of ordinary skill in the art will understand after reviewing the present disclosure.

Embodiments the novel bracket may include one or more of the following features in addition to the features recited hereinabove:

All tie wings extending gingival to occlusal from arch slot have equal length.

All tie wings having equal thickness mesially and distally.

There are no grooves between the tie wings on a same side (gingival or occlusal) for greater bracket strength.

Hooks of various types may be provided on embodiments of the novel bracket. In fact, there may be one, two, or three hooks on each such bracket.

Gingival hooks may be placed on the central tie wing, mesial tie wing, or distal tie wing.

A tooth attachment surface of the bracket body for adhering to a patient's tooth may have a mesh pattern, a character pattern, a dovetail pattern, and/or a regular or an irregular pattern of undercuts thereon.

The tooth attachment surface may be electrolytically etched; roughened, such as sandblasted or a method by which particles are attached to the tooth attachment surface to create a rough pattern either by a mechanical or chemical technique.

The novel bracket may include identification markings for assisting in identifying placement of the bracket and/or identifying a particular embodiment of the novel bracket. Such identification may include an ink marking, an etching, or one or more mold marks. Such markings may include numbers, letters, or symbols.

In another aspect of the present disclosure, a novel bracket cap or cover is provided, wherein the bracket cap frictionally hinges and pivots in the recess 1228 between: (a) the gingival (occlusal) tie wings of a bracket, and (b) the base of the bracket. In particular, the bracket cap includes a rod (denoted a “hinge” hereinbelow) that is pivotally secured across a mesial distal extent of the bracket in each (or at least one) recess between a wing of (a) above, and the bracket base. The configuration of hinge and the recesses is such that once the hinge engages the recesses, the bracket cap is attached to the bracket, it is has a bias toward closing a slot cover of the bracket cap over at least a portion of the opening of the slot or channel in which the archwire resides in the bracket. The bracket cap may be repeatedly pivoted between: (i) covering the opening of the slot or channel, and (ii) allowing full access to the slot or channel via the opening.

Various embodiments of the present disclosure are set forth in the attached figures and in the detailed description of the disclosure as provided herein and as embodied by the claims. It should be understood, however, that this Summary does not contain all of the aspects and embodiments of the present disclosure, is not meant to be limiting or restrictive in any manner, and that the disclosure as disclosed herein is and will be understood by those of ordinary skill in the art to encompass obvious improvements and modifications thereto.

Additional advantages of the present disclosure will become readily apparent from the following discussion, particularly when taken together with the accompanying drawings.

### BRIEF DESCRIPTION OF THE DRAWINGS

FIGS. 1-6I illustrate various views and embodiments of novel brackets 10. The drawings are not necessarily drawn to scale. Accordingly, slot 14 and liner 18 dimensions are not necessarily drawn to scale.

FIG. 7 shows a collection of sample brackets of various types that were used in an empirical study to determine the binding friction of the various bracket types, wherein one of sample bracket types is an embodiment of the novel bracket 10.

FIG. 8 shows a jig 804 used in the empirical study, wherein a sample collection of three brackets of the same type are configured on the jig for measuring both horizontal and vertical binding friction between these sample brackets and the archwire 16.

FIG. 9 illustrates how the brackets were secured to a brass mount 808 prior to being provided on the jig 804.

FIG. 10 is a bar graph showing the horizontal and vertical frictional forces generated when an archwire 16 was pulled through the collections of the various bracket types shown in FIG. 7, wherein substantially less frictional forces in both the horizontal and vertical directions were generated by the novel bracket 10.

FIGS. 11A through 11C show an embodiment of the novel bracket 10 used during successive phrases of an orthodontic treatment for realigning a patient's teeth.

FIG. 12 is a front view of a novel bracket cap 1204 for covering at least a portion of an archwire slot/channel extending mesially distally across a bracket such as the novel bracket 10, or another bracket type.

FIG. 13 is a front view of the novel bracket cap 1204 in combination with a triple wing bracket such as the novel bracket 10.

FIG. 14 is a side view of the novel bracket cap 1204 in combination with a bracket.

### DETAILED DESCRIPTION

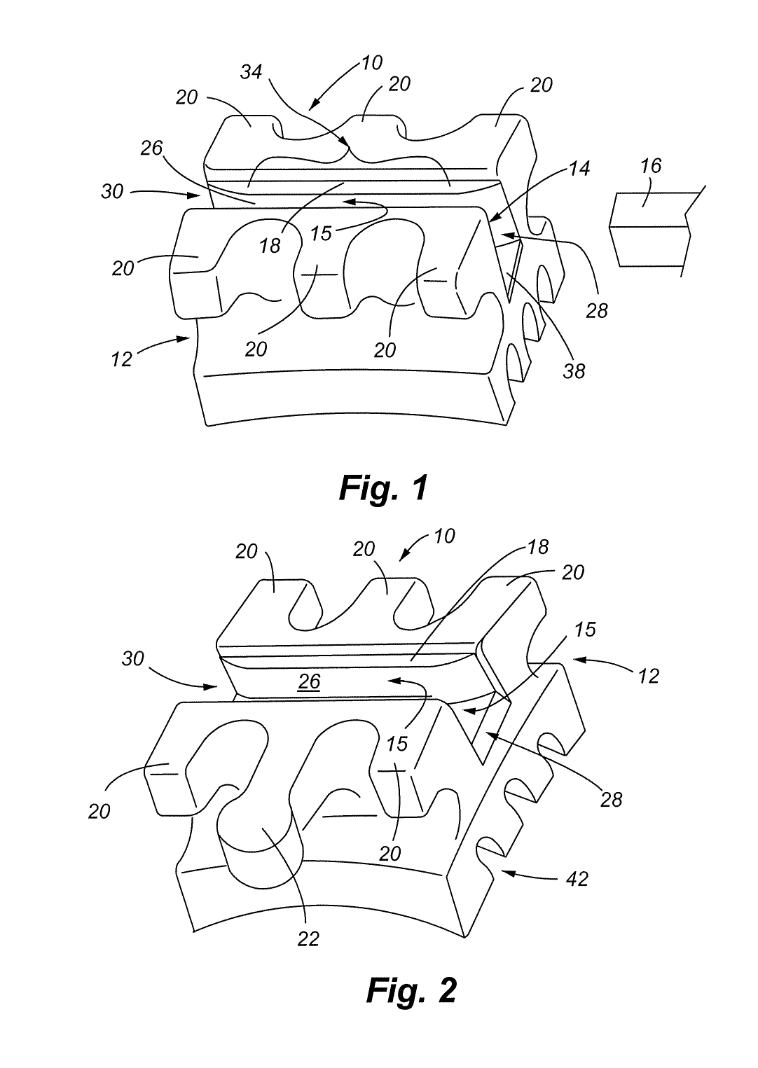

Various embodiments of a bracket 10 are disclosed in FIGS. 1-6I, wherein each embodiment includes: (a) a bracket body 12 having an archwire slot 14, and (b) a liner 18 for the slot 14 providing an archwire receiving channel 15 therein, preferably an 18 karat gold liner, wherein the liner assists with reducing binding friction between the bracket 10 and the archwire 16. The bracket body 12 may be made of a variety of materials, but preferably is a ceramic material that is non-opaque or translucent. For example, the bracket body 12 may be composed of a polycrystalline alumina material, alumina (aluminum oxide) or zirconia. Note that in other embodiments the bracket body 12 may be composed of various materials (e.g., plastic, polyurethane, or a ceramic composite) having a Knoop hardness of at least 500 kg/mm².

Referring now to FIG. 1, a perspective view of one embodiment of a bracket 10 is shown. The bracket 10 of FIG. 1 (as well as the bracket 10 shown in FIGS. 2-6F) features a triple tie wing configuration, wherein there are three wings 20 on each of the gingival and occlusal sides of a slot 14, such wings being for, e.g., securing the bracket and a corresponding archwire 16 together as will be described further hereinbelow. The liner 18, located within the archwire slot 14, includes gingival and occlusal sidewalls 26 as well as a floor 38. Note that the sidewalls 26 may extend the entire height of the slot 14, and in particular, the body 12 does not overhang the sidewalls at any opening to the channel 15. The liner 18 has a substantially lower coefficient of friction (e.g., binding friction) with a plastic or metal archwire 14 (e.g., made of stainless steel, titanium, chromium, cobalt, nickel, or alloys thereof) than, e.g., a bracket body 12 made of ceramic other corresponding materials of similar hardness and/or abrasiveness. In particular, the bracket body 12 may typically have a Knoop hardness that is greater than 1200 kg/mm² up to 3200 kg/mm², whereas the material of the liner 18 is relatively soft compared to the bracket body 12, and accordingly has a reduced Knoop hardness in the range of 50-1000 kg/mm² (e.g., a range of about 1.5% to about 83% of the Knoop hardness of the body 12), and more preferably in the range of 100-500 kg/mm² (e.g., a range of about 3% to about 43% of the Knoop hardness of the body 12), most preferably in a range of 10% to 30% of the Knoop hardness of the body 12. Thus, the Knoop hardness of the liner 18 is similar to the Knoop hardness of the archwire 16 in order to reduce the likelihood of galling or abrasive wear of the archwire. In addition to a gold liner as mentioned above, the liner 18 may be made from, but are not limited to, platinum, palladium, silver, stainless steel. Moreover, in other embodiments, the liner 18 may be made of plastic, polyurethane, or a composite thereof. The liner 26 may also serve to dissipate localized areas of relatively high stress concentrations that might otherwise be imposed by the archwire on the body 12, thereby reducing the likelihood that the body 12 will fracture in use. Additionally, the process of affixing the liner 18 in the bracket body 12 may also strengthen and prevent breakage of the bracket body as disclosed in, e.g., U.S. Pat. No. 5,380,196 incorporated herein fully by reference.

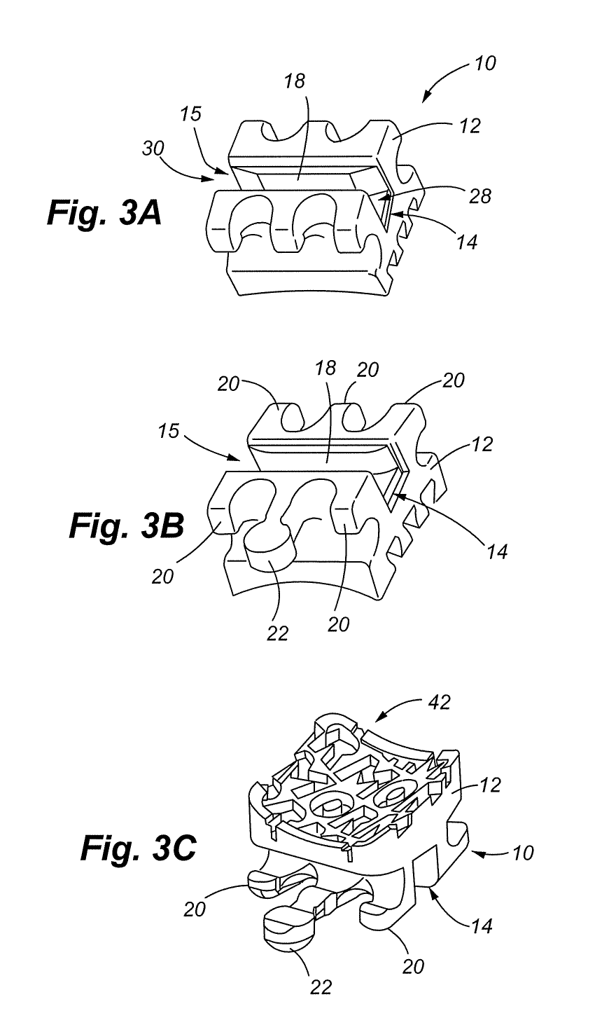

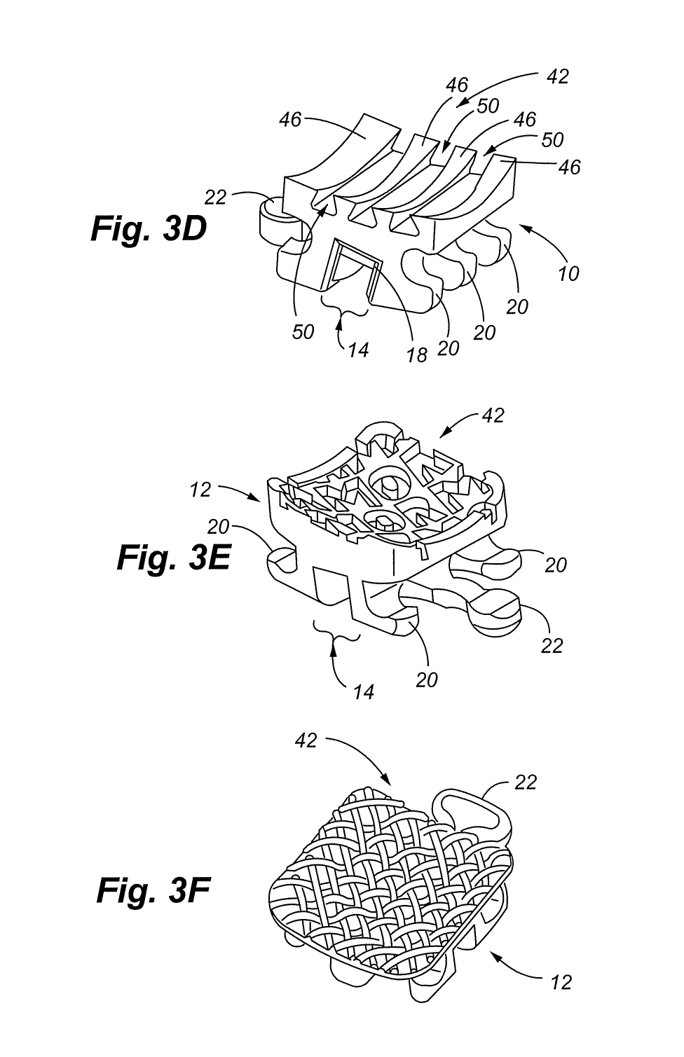

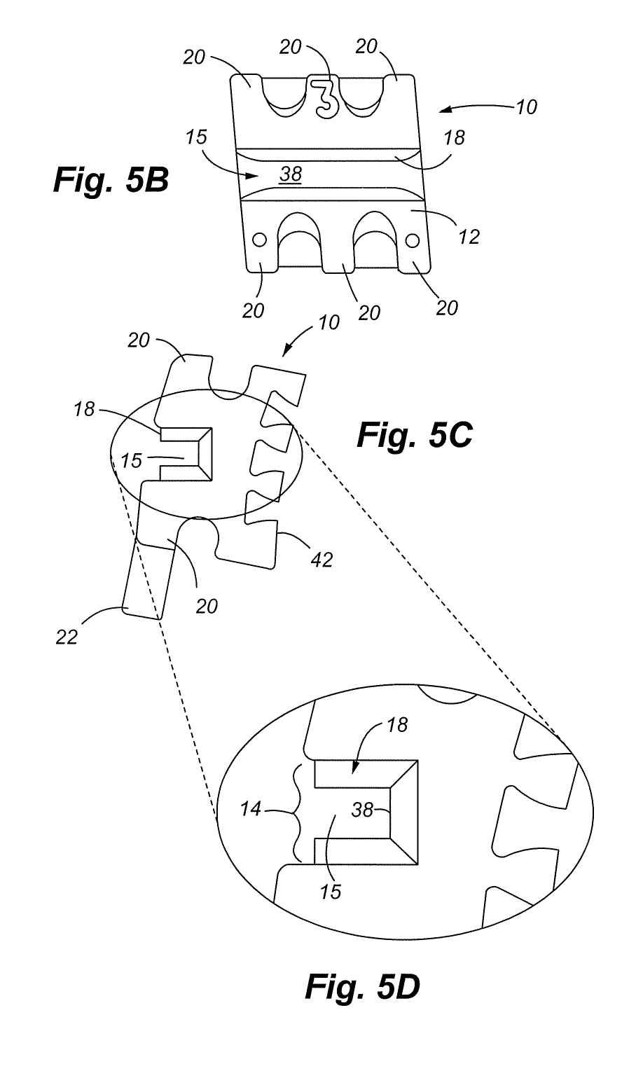

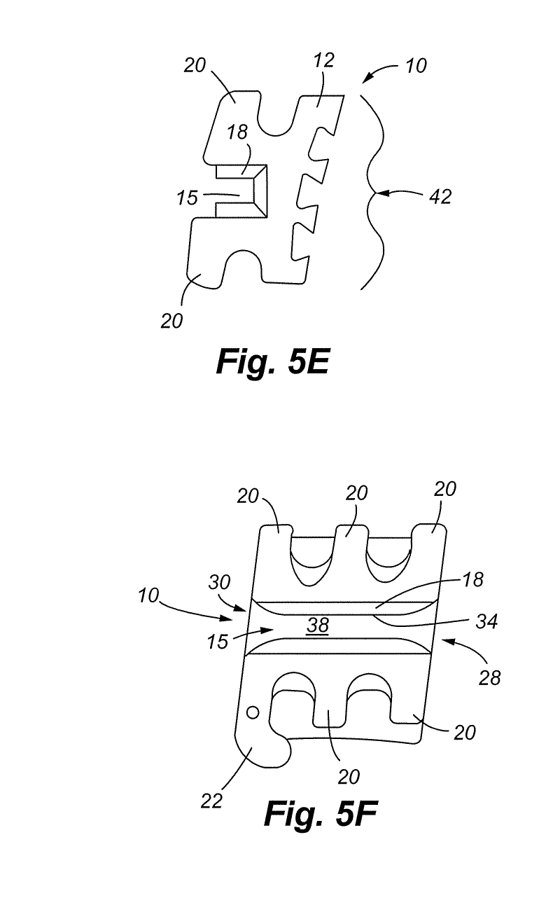

In at least the bracket 10 embodiments shown in most of the FIGS. 1-6F, the liner 18 has flared (e.g., curved as in FIG. 1 or chamfered as in FIG. 3A) mesial ends 28, and distal ends 30, wherein the channel 15 width is greater at the mesial and distal ends than in a center portion of the channel, generally identified as 34 in FIG. 1, this center portion generally including straight and parallel portions of the sidewalls 26 (e.g., FIGS. 1 and 5F) that extend in a range of 25% to 80% of the mesial-distal length of the liner 18. For example, the liner sidewalls 26 (FIGS. 1 and 2) may have mesial and distal ends that are approximately 10% to 100% wider (more preferably 80% to 100% wider) than the narrowest portion of the liner sidewalls (at, e.g., the midpoint of a mesial-distal axis extending the length of the liner 18), and wherein the narrowest portion of the liner 18 is at most 1% to 5% wider than the widest archwire 16 to be inserted into the liner. In addition, although the floor 38 of the liner 18 may be a flat surface, in at least one embodiment, the floor may also be flared (e.g., chamfered or curved) at its mesial and distal ends 28, 30 as shown in FIG. 2. In particular, the floor 38 may slope away from the opening of the liner 18 at the liner's mesial and distal ends by 50% of the depth of the liner at its shallowest point (i.e., the height of the sidewalls 26 may increase by 50% at their mesial and distal ends). These curved or chamfered features provide the following advantages: (1) there is a reduction of binding friction between an archwire 16 and the slot 14 during patient treatment since there is a reduction in contact surface area between the liner 18 and the archwire 16, and (2) there is a significant improvement in the orthodontist's ability to insert an archwire 16 within the slot 14. It is noted that, although shown in a triple tie wing bracket 10, the liner 18 may also be used with single or twin tie wing brackets with or without any flaring of the liner at its mesial and distal ends as one of ordinary skill in the art will understand.

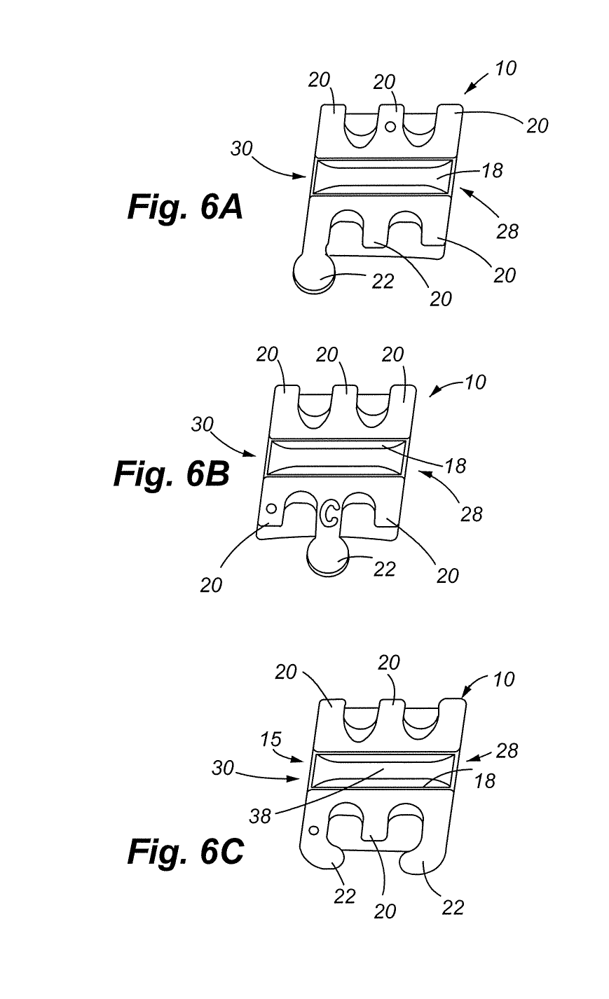

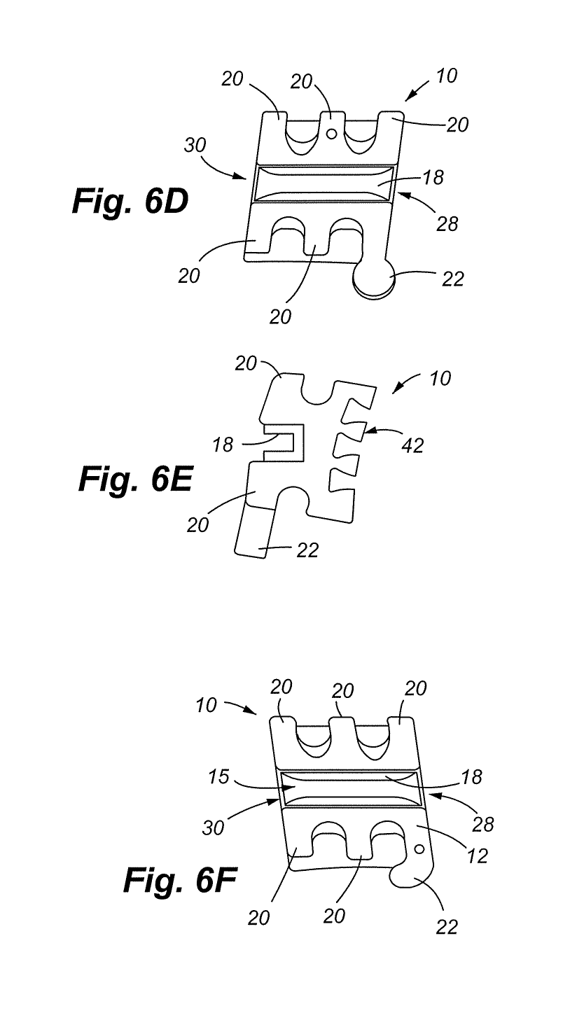

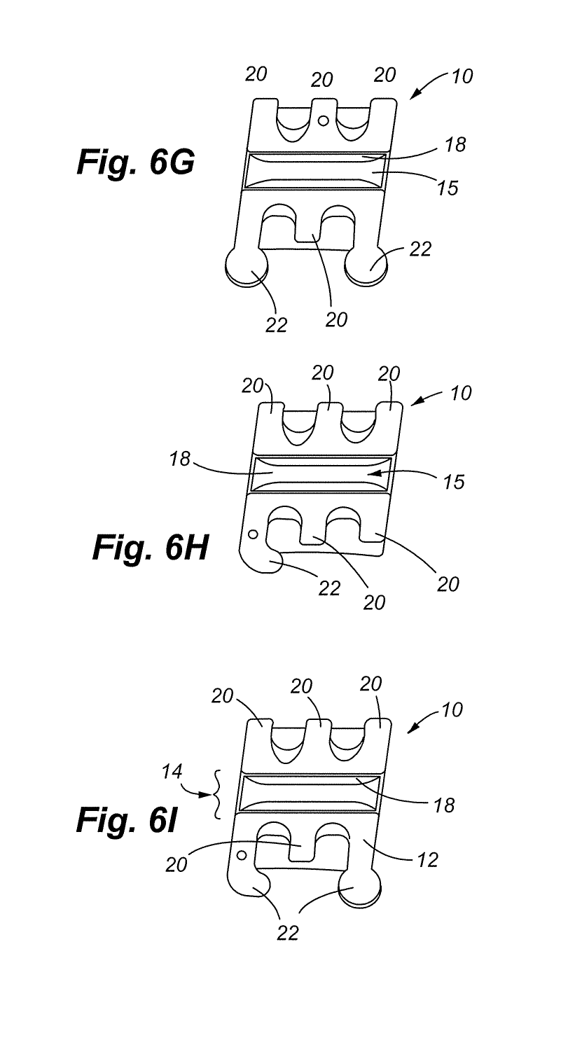

Referring to FIG. 2, a bracket 10 is shown, wherein the bracket body 12 includes a hook 22 for attaching additional connections between the bracket 10 of FIG. 2 and other orthodontic devices. Additional figures herein show a variety of other hook placements and configurations, e.g., FIGS. 5F, 6A, 6C, 6D and 6F.

Referring now to FIGS. 3C-3F, various embodiments of the tooth attachment surface 42 of the bracket body 12 are shown. Note that the attachment surface 42 may include indicia therein such as the “RMO” lettering recessed or stamped into the attachment surface of FIG. 3C or 3E. Alternatively, the attachment surface 42 may include rails 46 (FIG. 3D) extending between the mesial and distal sides of the body 12, wherein the rails are may be wider at their ends than at their centers, and wherein the channels 50 between the rails may have a generally trapezoidal cross section, wherein an extent of the channel offset from the tooth to which the bracket is to attach is greater in the gingival-occlusal direction than the opening of the channel along its length in the mesial-distal direction. Note that the configuration of rails 42 and channels 50 shown in FIG. 3D is advantageous in that when an adhesive for affixing the attachment surface 42 to a tooth hardens, the adhesive will likely substantially fill the channels 50. Accordingly, since the channels 50 provide greater surface area (than a smoother such surface), this greater area provides increased area on the bracket to which the adhesive can adhere. Additionally, since the channels 50 have a trapezoidal cross section, wherein the base of each such trapezoid is offset from the tooth, once the adhesive hardens within the channels, the hardened adhesive acts like a wedge in each of the channels to further secure the bracket to the tooth.

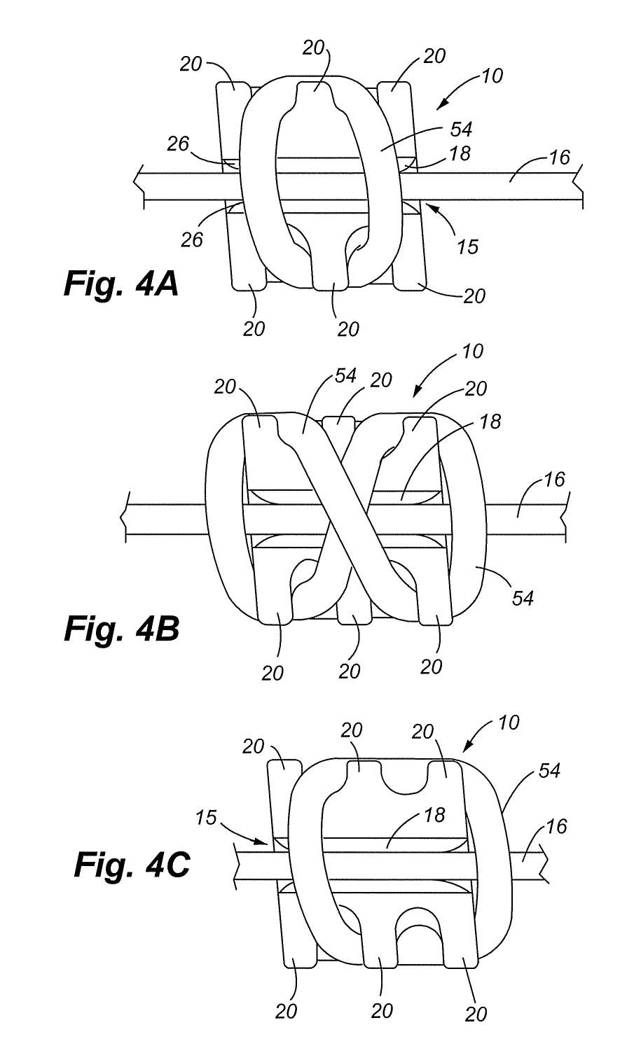

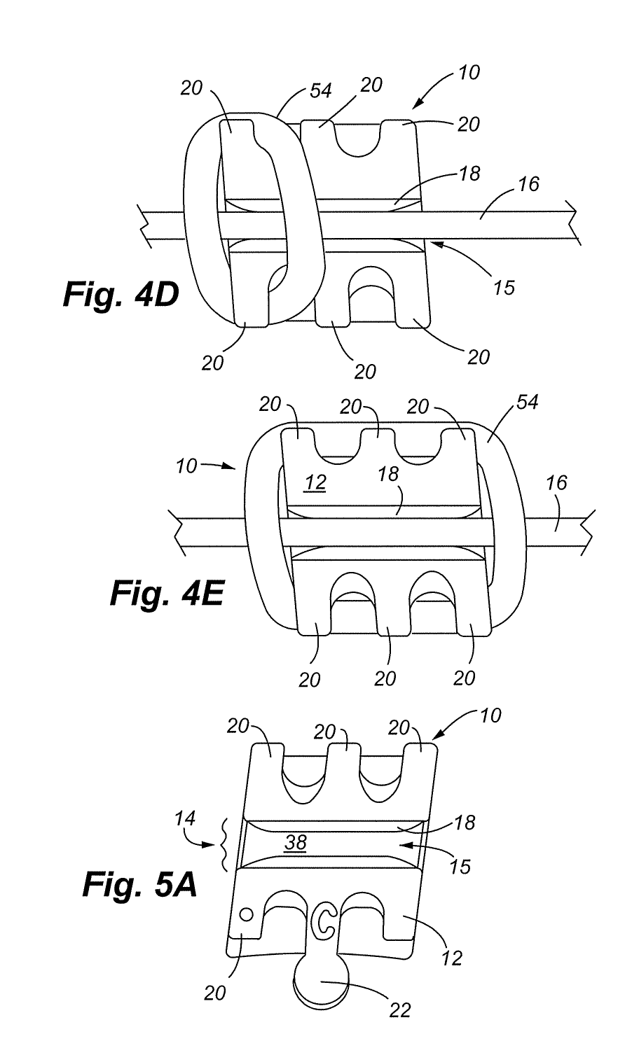

As noted herein, a bracket 10 preferably comprises a triple tie wing configuration. Such a triple wing configuration offers a variety of advantages when combined with the liner 18 of the archwire slot 14. More particularly, the bracket 10 allows for at least five different ligating options or modes, wherein each of these options provides distinct advantages. In FIG. 4A a first ligating mode is shown, wherein a ligating band 54 is positioned along the center tie wings 20. This configuration results in a relatively small alignment force, which is advantageous during early stage orthodontic treatment when rapid tooth realignment is desired. For this ligating mode, the alignment force may be in the range of 0.0 Newtons (“N” herein) to 1.5 N and more preferably in the range of 0.00 N to 1.0 N, and most preferably in the range of 0.00 to 0.50 N. Additionally, note the binding friction (i.e., the friction force along the direction of movement of the archwire when the archwire 16 is in physical contact with a section of the liner 18) for this mode is relatively low. Note that such a configuration is not possible in a twin tie wing bracket.

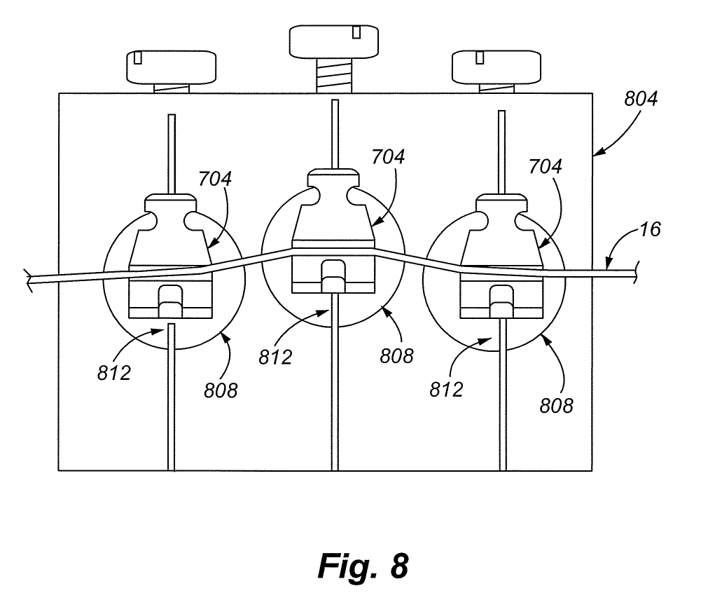

Referring now to FIG. 4B, a second ligating mode is shown for a bracket 10, wherein the bracket 10 includes a ligating band 54 forming a “figure 8” around the various tie wings 20. This configuration results in a relatively large alignment force, which is advantageous during late stage orthodontic treatment, for maximum control in fine tuning alignment. For this ligating mode, the alignment force may be in the range of 0.0 N to 10 N, and more preferably in the range of 0.0 N to 7.0 N, and most preferably in the range of 1.0 N to 5.0 N. Additionally, note the binding friction (i.e., the friction force along the direction of movement of the archwire when the archwire 16 is in physical contact with a section of the liner 18) for this mode is relatively high.

Referring now to FIG. 4C, a third ligating mode is shown for a bracket 10 wherein a ligating band 54 is positioned eccentrically on the bracket around the center wings 20 and one of either the mesial or distal tie wings 20. Such a configuration allows for minor rotation of the subject tooth to which the bracket 10 is attached. For this ligating mode, the alignment force may be in the range of 0.5 N to 2.00 N, and more preferably in the range of 0.5 N to 1.5 N, and most preferably in the range of 0.5 N to 1.00 N. Additionally, note the binding friction (i.e., the friction force along the direction of movement of the archwire when the archwire 16 is in physical contact with a section of the liner 18) for this mode is moderately light. Again, such configuration is not possible in a twin tie wing bracket.

Referring now to FIG. 4D, a fourth ligating mode is shown for a bracket 10, wherein a ligating band 54 is positioned about the wings 20 of only one of the mesial or distal ends of the bracket. This fourth ligating mode results in an alignment force that may induce a substantial rotation of the tooth to which the bracket 10 is attached. For this ligating mode, the alignment force may be in the range of 0.00 N to 2.5 N, and more preferably in the range of 0.5 N to 2.00 N, and most preferably in the range of 1.00 N to 1.5 N. Additionally, note the binding friction (i.e., the friction force along the direction of movement of the archwire when the archwire 16 is in physical contact with a section of the liner 18) for this mode is light.

Referring to FIG. 4E, a fifth ligating mode is shown for a bracket 10, wherein a ligating band 54 is positioned around the bracket body 12 for providing an intermediate alignment force. In particular, for this ligating mode, the alignment force may be in the range of 0.5 N to 4.00 N, and more preferably in the range of 0.5 N to 3.0 N, and most preferably in the range of 0.5 N to 2.5 N. Additionally, note the binding friction (i.e., the friction force along the direction of movement of the archwire when the archwire 16 is in physical contact with a section of the liner 18).

Referring to FIGS. 5A, 5B, 5F, 6B, 6C, 6D, 6F, 6G, 6I, these figures show various markings or indicia on the bracket 10 for assisting in identifying the bracket and/or for assisting in aligning the bracket on the tooth to which it is to be attached. For example, FIG. 5A shows indicia represented as a small circle on the left bottom most wing 20 used for alignment, and a “C” on the body extension terminating in the hook 22. In FIG. 5B such indicia is shown again as small circles on the lower mesial and distal wings 20. Additionally, a “3” is shown on the middle upper wing 20 for bracket identification. Similar indicia are shown on the brackets of FIGS. 5F, 6B, 6C, 6D, 6F, 6G, and 6I.

When combined with a liner 18, the triple tie wing bracket offers advantages over a twin tie wing bracket because more alignment force control is provided to the orthodontist, while minimizing binding friction between the bracket and the archwire 16. The curved end portions of the liner 18 reduce binding friction, while the triple tie wing configuration offers early to late stage treatment versatility. Such advantages result in improved patient comfort and reduced treatment time. In addition, a gold liner 18 improves the appearance of the bracket, thereby improving patient satisfaction and cooperation. Note that embodiments of brackets 10 can be provided for various archwire 16 sizes, including sizes (diameters or widths) of 0.004 inches to 0.075 inches. In particular, the narrowest widths of the channels 15 can be varied to snuggly accommodate a corresponding archwire 16 size such that such widths are, e.g., approximately 1% to 5% wider than the corresponding archwire.

The following study provides evidence of the advantageous combination of a triple wing bracket 10 having a liner 18 flared at its ends.

### Study of Kinetic Frictional Forces on Brackets

### Materials and Methods

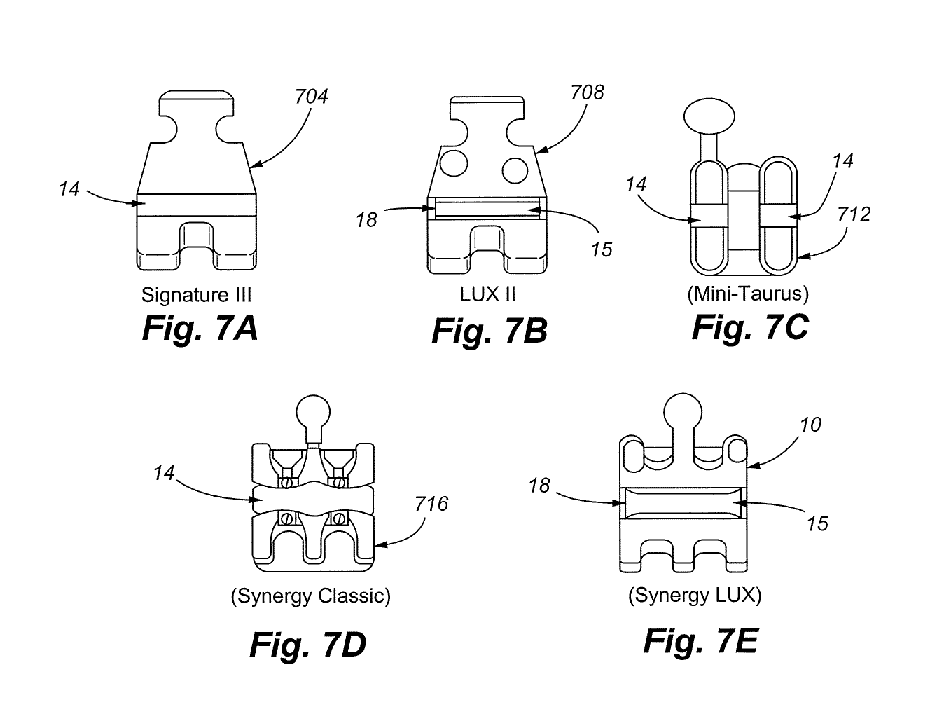

A total of 180 brackets were tested as follows:
36 polycrystalline (ceramic) conventional brackets 704 (Signature™ III, RMO, Denver Colo.) as shown in FIG. 7A,
36 ceramic brackets 708 with gold liners 18 (Luxi™ II , RMO, Denver Colo.) as shown in FIG. 7B,
36 conventional stainless steel brackets 712 (Mini-Taurus® RMO, Denver Colo.) as shown in FIG. 7C,
36 stainless steel brackets 716 (Synergy® Classic, RMO, Denver Colo.) with curved slots 14 that are also flared at their ends as shown in FIG. 7D,
36 ceramic triple wing brackets 10 (Synergy LUX, RMO, Denver Colo.) with a gold liner 18 flared at its ends as shown in FIGS. 7E, wherein the liner sidewalls 26 (FIGS. 1 and 2) have mesial and distal ends that are approximately 10% to 30% wider (more specifically 15% to 25% wider) than the narrowest portion of the liner sidewalls (at, e.g., the midpoint of a mesial-distal axis extending the length of the liner 18), and wherein the narrowest portion of the liner 18 is at most 1% to 5% wider than the widest archwire 16 to be inserted into the liner
All the brackets used in this study were maxillary premolars brackets with the following identical features: nominal slot dimension (0.022 inch), prescription: torque −7°, angulation 0° and rotation 0° as shown in the following table.

Table of Test Bracket Configurations

| | | | | Information |
|---|---|---|---|---|
| | | | Slot | (torque, |
| | | | channel | angulation, |
| Bracket | Type | Composition | width | rotation) |
| Synergy | Triple wing | Polycrystalline | .022″ | −7° 0° 0° |
| LUX | bracket body 12 | body 12 with | | |
| bracket 10 | with flared | an 18-karat | | |
| | archwire channel | gold liner 18. | | |
| | sidewalls 26, and | | | |
| | flared floor 38. | | | |
| Luxi ™ II | Twin wing (one | Polycrystalline | .022″ | −7° 0° 0° |
| bracket 708 | side) | body 12 with | | |
| | | a 18-karat | | |
| | | gold liner | | |
| Signature ™ | Twin wing (on | Polycrystalline | .022″ | −7° 0° 0° |
| III bracket | side) | (no liner 18) | | |
| 704 | | | | |
| Synergy ® | Tripe wing | Stainless steel | .022″ | −7° 0° 0° |
| Classic | | (no liner 18) | | |
| bracket 716 | | | | |
| Mini- | Twin wing | Stainless steel | .022″ | −7° 0° 0° |
| Taurus ® | | (no liner 18) | | |
| bracket 712 | | | | |

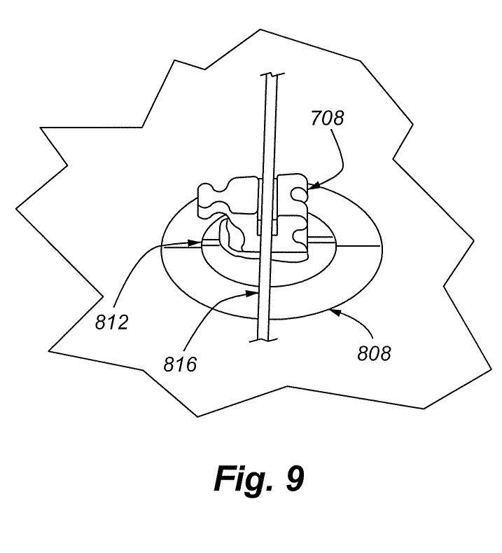

A special metal jig 804 (FIG. 8) was assembled in order to fix 3 brackets of the same type (i.e., one of bracket types shown in FIG. 7) in any vertically and horizontally misaligned state. FIG. 8 shows the jig 804 having three brackets 704 attached thereto. The inter bracket distance is 7 mm and the central bracket 704 is set 1 mm up compared to the remaining two brackets 704 in the vertical direction; and 1 mm out toward the viewer in the horizontal direction. Each test bracket was individually bonded, using composite resin (Mono Lok; RMO, Denver Colo.), to a brass mount 808 in a setting apparatus before being provided to the jig 804. Each brass mount 808 is cylindrical, with a hole (not shown) to retain the resin in order to achieve physical retention to the corresponding bracket. Each brass mount 808 has a midline 812 to act as a guide for reproducible bond position of the bracket and for correct positioning of the brass mount 808 in the jig 804. Bracket bonding was achieved by positioning a bracket on the brass mount 808, using a support with a 0.016×0.022 inch size stainless steel wire 816 as shown in FIG. 9. Once the brackets were bonded to their corresponding brass mounts 808, sets of three bracket-mount pairs were provide to the jig 804 in such a way that the biggest size archwire (0.022 inch) 16 (FIG. 8) used filled up the entire bracket slot 14 height so as to enhance the information obtained from the slot and bracket positioning. Lastly, a metal ligature (i.e., preformed ligature wire 0.010″ RMO, Denver Colo.) was applied for securing the archwire 16 into contact with the base of the slot 14. Thus, the measurements of the frictional forces of the archwire 16 moving within its three brackets were not substantially influenced by adverse tipping, torsion or rotational movements.

All the archwires 16 used in the frictional testing on the jig 804 were straight thermal NiTi 0.014 inch wires (Thermaloy. RMO, Denver Colo.). This particular archwire 16 was used because it is the most common archwire used for commencing orthodontic realignment. The ligatures used to tie these archwires to the brackets in the jig were elastic Synergy low friction ligatures (RMO, Denver Colo.), ligated conventionally in all the brackets except for triple wing brackets 10 and 716 (FIGS. 7D, 7E). Brackets 10 and 716 were tied on the center wing only in order to utilize the low frictional force for advanced sliding mechanics, as described above and shown in FIG. 4A.

### Measurement Technique

A friction testing machine was designed and made by the Istituto per i Processi Chimico Fisici (IPCF) of the Consiglio Nazionale delle Ricerche (CNR) in Messina (Italy), especially for the friction testing of the brackets. The testing machine included a static carriage, which supports the test jig 804, wherein the jig is able to slide along two vertical parallel rods with four smooth linear ball bearings. The static carriage which holds the test jig is fixed to a vertical rod which acts on a force sensor. The output from the force sensor was read through an interface and fed into a computer. The archwire 16 (as in FIG. 8) passing through the brackets mounted to the jig 802 on the static carriage, was fixed to a moving carriage that was driven by a computer controlled step motor. The step motor drove the moving carriage at a constant speed of 4 mm/minute. The corresponding frictional force measured by the sensor varied during the motion due to the frictional coupling between the moving archwire 16 and the three brackets. Tests were carried out at 37° C. in order to maintain an active state in the archwire 16 and in a dry condition state. The computer calculated the average kinetic friction over 100 data points, while moving the archwire 16 through its corresponding set of three brackets for length of 5 mm along the archwire. A single test was carried out with each set of 3 new brackets, elastic ligatures and a corresponding archwire. At the end of each test, the testing machine was turned off, the brackets and archwire assembly were removed, and a set of three new brackets were installed on the jig 804 to eliminate the influence of wear. Six trials were performed for each bracket/archwire combination. Before starting each test the three brackets, the archwire 16, and the corresponding ligatures were cleaned with 90% ethanol to remove surface debris.

Once the frictional data was obtained for each type of bracket in FIGS. 7A-7E, the data was displayed and recorded by software on a XY recorder. The XY recorder measured the kinetic coefficient of friction with respect to both horizontal (X) and vertical (Y) vectors. Measurement of the coefficient of friction in both the horizontal (X) direction and the vertical (Y) direction was necessary in order to accurately quantify the results for a predetermined misaligned configuration of brackets in the jig 804.

### Results

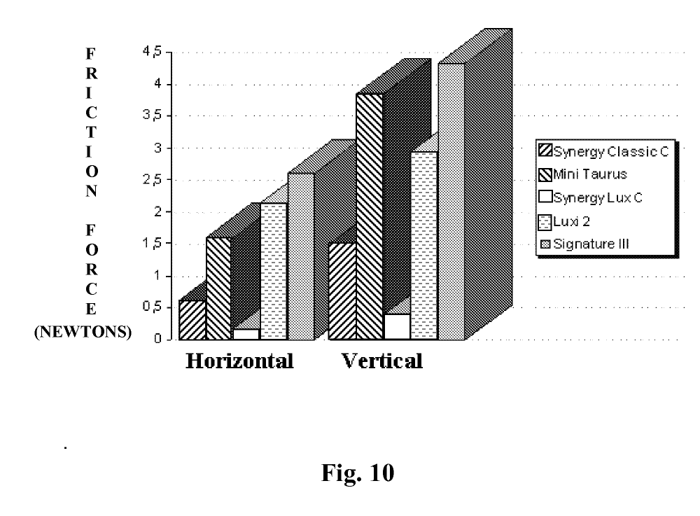

The results of the frictional forces exerted by the different bracket types are shown in FIG. 10. The binding friction developed in the test samples of three non-aligned brackets was evaluated in two dimensions: horizontal and vertical directions. For the horizontal direction, there were large differences friction forces between: (a) the triple wing brackets 10 and 716, and (b) the more conventional brackets 704, 708, and 712. The Synergy LUX bracket 10 showed the lowest friction force of approximately 0.15 Newtons followed by the Synergy® Classic 716, the Mini-Taurus® 712, the Luxi™ II 708, and finally, the Signature™ III 704. The differences between the triple wing brackets 10 and 716, and the other bracket types were even wider for the vertical misalignment. The Synergy LUX bracket 10 again exerted the lowest friction force (approximately 0.35 Newtons), then the Synergy® Classic bracket 716, followed by the LUXi™ II bracket 708, the Mini-Taurus® bracket 712, and lastly the Signature™ III bracket 704.

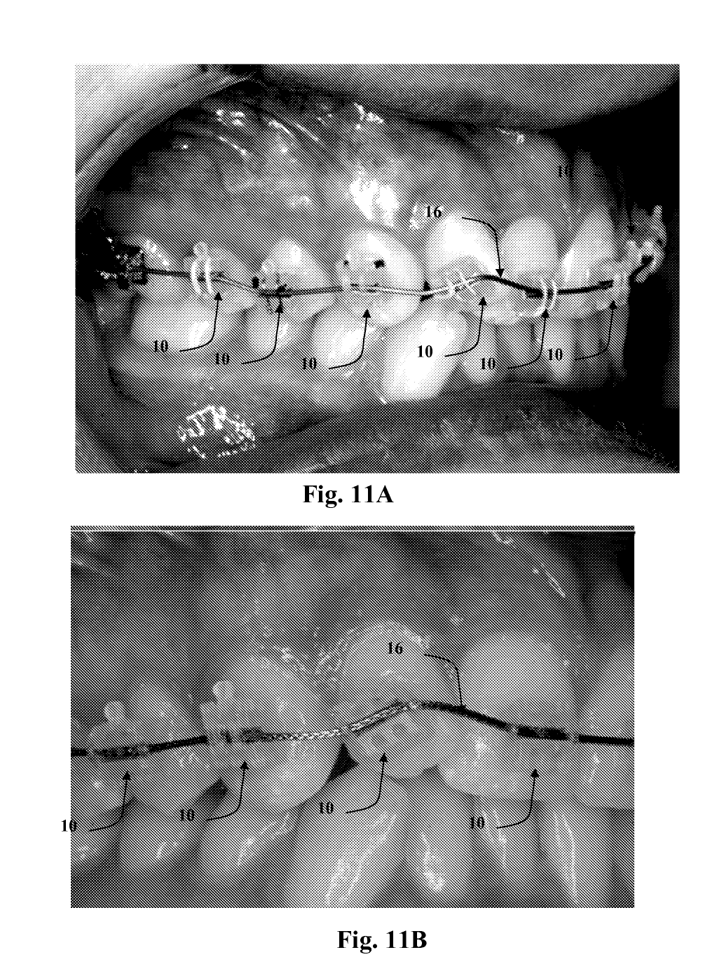

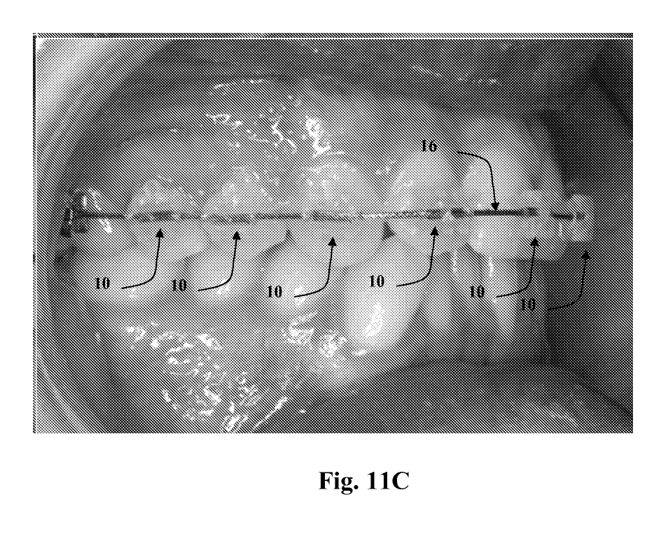

Accordingly, a bracket 10 having the combination of a triple wing configuration, a liner 18 (of appropriate Knoop hardness, e.g., in the range of 50-1000 kg/mm², and more preferably in the range of 100-500 kg/mm²), and wherein the liner 18 (as well as possibly the slot 14) are flared at its mesial and distal ends in the range of approximately 10% to 100% wider (more preferably 70% to 80% wider) as described hereinabove show a substantial reduction in the coefficient of friction over other types of brackets, such as tripe wing brackets without a liner 18, and brackets that have liners but are not flared at their mesial and distal ends. Moreover, such brackets 10 are particularly useful in the initial stage of orthodontic treatments for teeth realignment since an orthodontist may need to induce substantial three dimensional curves into an archwire 16 in order to attach the archwire and brackets together appropriately for commencing initial movement of a patient's teeth. For example, FIGS. 11A-11C shows stages of an orthodontic treatment with brackets 10, wherein FIG. 11A shows the initial fitting of the brackets with the archwire 16 being substantially curved in three dimensions. FIG. 11B shows a second stage of treatment where the archwire 16 is less curved, and FIG. 11C shows a final stage of treatment where the archwire is substantially straight or parallel with a mesial-distal axis.

U.S. Pat. No. 3,504,438 (fully incorporated herein by reference) proposes an orthodontic bracket made of a stainless steel or chrome alloy and coated with a polymeric material such as polytetrafluoroethylene to provide a relatively low coefficient of friction for sliding movement of the bracket. U.S. Pat. No. 5,203,804 (which is assigned to the assignee of the present invention) describes the use of a hard carbon coating such as a diamond-like coating on a metallic orthodontic archwire or on a metallic or ceramic orthodontic bracket.

### Bracket Cap

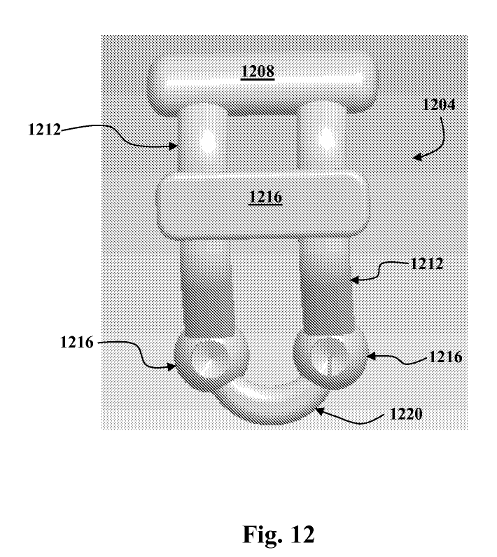

Brackets, such as embodiments of bracket 10, may be provided with a cover or cap for assisting in securing an archwire 16 in the bracket slot (e.g., the channel 15 hereinabove). FIGS. 12-14 show an embodiment(s) of a novel bracket cap 1204. The cap 1204 includes a hinge 1208, one or two cross members 1212, a slot cap 1216, at least one cap holder 1220, and an optional placement/removal tab 1224. Each cross member 1212 connects to the hinge 1208. Each cross member 1212 also attaches to the slot cap 1216 in a midsection of the length of the cross member. The end of each cross member 1212 opposite its connection to the hinge 1208 attaches to a corresponding cap holder 1220, and the placement/removal tab 1224 may be attached to each of the one or more cap holders. The novel bracket cap 1204 may be manufactured from metal, plastic, a composite, an acrylic or a ceramic.

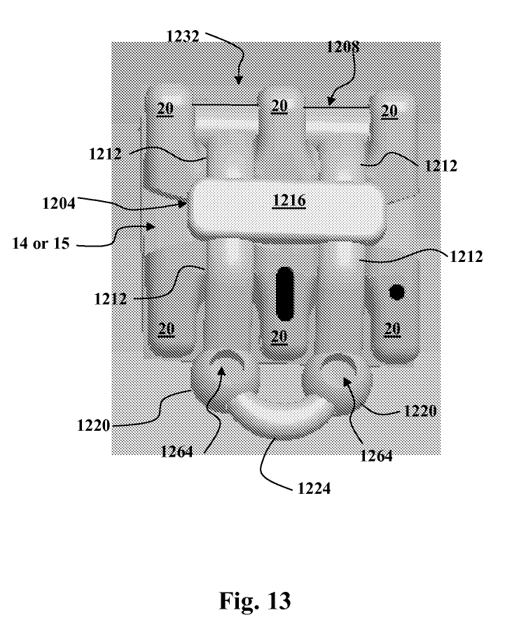

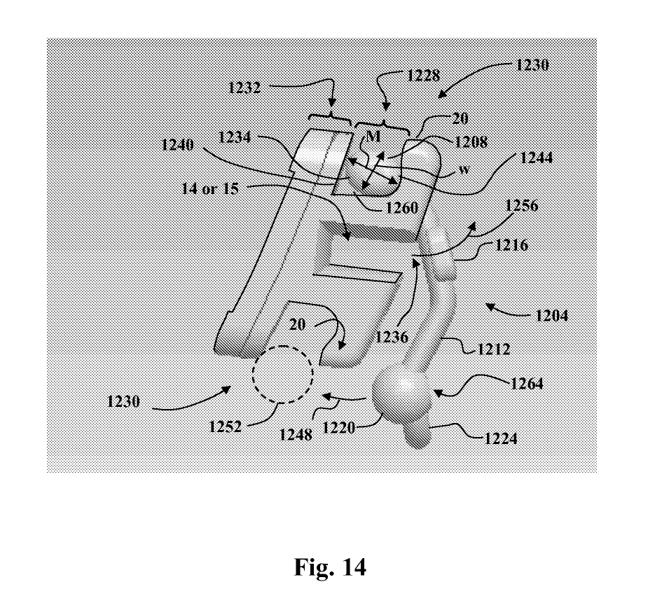

When the bracket cap 1204 is provided on a bracket (e.g., bracket 10), as shown in FIGS. 13 and 14, the hinge 1208 is provided in the recesses 1228 between the base 1232 of the bracket and a corresponding one of the wings 20 on one of the gingival or occlusal sides 1230 of the bracket (FIG. 14 shows one such recess 1228; however, all such recesses may be identical). The hinge 1208 is rotatable in the recesses 1228 for rotating each cross member 1212 in and out of the spaces between the wings 20 on a same side (gingival or occlusal) of the bracket. Accordingly, when the slot cap 1216 is closed over the slot/channel 14 or 15 (i.e., opening 1236, FIG. 14), each end of each cross member resides substantially entirely in a corresponding space between two of the wings 20 (or between a wing 20 and a hook 22). Conversely, when the slot cap 1216 provides full access to the slot/channel 14 or 15, at least the end of each cross member 1212 not connected to the hinge 1208 is free of the spaces between the wings 20 (or between a wing 20 and a hook 22).

The hinge 1208 may be cylindrical; alternatively (and more preferably) the hinge may have an oval cross section 1234 as indicated by the hinge end view shown in FIG. 14, wherein the minor axis “w” has a length less than the major axis “M”. Such an oval cross section may be oriented relative to the cross members 1212 so that the hinge 1208 is biased toward a position that causes the slot cap 1216 to cover and entirely close the opening 1236 of at least one of: the bracket slot 14 and the bracket channel 15 (if a liner 18 is present). In particular, when the slot cap 1216 entirely closes the opening 1236, the orientation of the hinge 1208 is such that its minor axis “w” may extend generally in a direction of approximately 0 to 270 degrees, more preferably 45 degrees relative to a width of the recess 1228 going through a center point of the cross section 1234 (i.e., where the minor axis “w”, and the major axis “M” intersect). Accordingly, in this orientation, the width of the hinge 1208 across the recess 1228 is slightly larger than the corresponding width of the recess 1228 without the hinge therein, and the sidewalls 1240 and 1244 are slightly biased apart by the hinge such that these sidewalls are in tension with the hinge for resiliently returning to their non-biased positions. Thus, this tension results in a friction and/or a biasing force which at least results in the slot cap 1216 being locked into a position of completely closing over the opening 1236, and in some embodiments causing the slot cap 1216 to forcibly move to (and remain) completely closed over the opening 1236 when the slot cap is near to closing over the opening. In particular, the biasing force may be generated by the sidewalls 1240 and 1244 resiliently moving to a less deformed state. Note that such forcible movement of the bracket cap 1204 may occur when all distances between the corresponding contacting portions of the bracket and the slot cap 1216 (when the slot cap is closed) are within a distance of, e.g., about 50% of the width of the opening 1236. Accordingly, the position of the slot cap 1216 relative to the opening 1236 can, in one embodiment, forcibly move the slot cap to close over the opening 1236. That is, the intermediate position shown in both FIGS. 13 and 14, wherein the slot cap 1216 only partially occludes the opening 1236, is such that the slot cap may be biased toward entirely closing the opening 1236. Note that when the slot cap 1216 closes over the opening 1236, the at least one cap holder 1220, moves along the direction of arrow 1248 to the position 1252 shown as dashed outline 1252.

When it is desired to remove the slot cap 1216 from the opening 1236, i.e., pivot the cross members 1212 according to the direction arrow 1256, the friction and/or biasing force from the sidewalls 1240 and 1244 pressing on the hinge 1208 must be overcome to perform the pivot. Due to the sidewall 1244 being concave adjacent the closed end 1260 of the recess 1228, the sidewall friction and/or biasing force on the hinge 1208 does not substantially increase when pivoting of the cross members 1212 in the direction of arrow 1256. Moreover, since the biasing tension does not substantially increase there is substantially reduced likelihood of the hinge 1208 or the sidewalls 1240 and/or 1244 permanently deforming, cracking or breaking during such pivoting.

Accordingly, from the above description it is evident that the resilient nature of the sidewalls 1240 and 1244 act as a spring mechanism for maintaining a tension on the hinge 1208 in a manner that keeps the slot cap 1216 securely covering the opening 1236 during even extended periods between visits to the orthodontist. However, the rotational leverage that can be applied by, e.g., an orthodontist via a cap holder 1220 or the placement/removal tab 1224 is effective for overcoming the friction and/or biasing force from the sidewalls 1240 and 1244 pressing on the hinge 1208.

As can seen in FIGS. 12 and 13, the cap holders 1220 each include detents 1264 where orthodontic tweezers may used to grasp the bracket cap 1204 for positioning it on a bracket, closing the slot cap 1216 over the opening 1236, and/or pivoting the slot cap away from the opening 1236. Note that during the initial positioning of the bracket cap 1204 so that the hinge 1208 is in the recess 1228 of a bracket, the orthodontist orients the bracket cap so that the minor axis “w” of the hinge 1208 spans or at least parallel to the opening of the recess 1228. In such a position, the hinge 1208 will slide or snap into the recess 1228 without substantial effort, and in particular, without damage to the bracket, the bracket cap 1204, and/or harm or bruise the patient to which the bracket is affixed. Subsequently, the orthodontist may use the tweezers' grasp of the detents 1264 to rotate the slot cap 1216 for closing the slot/channel opening 1236. Note, when rotating the detents 1264, the hinge 1208 rotates in a manner so that the length of the major axis “M” forces the sidewalls 1240 and 1244 further apart, and accordingly increases the tension of the sidewalls on the hinge for locking the hinge in the recess, and generating the desired friction for inhibiting undesired movement of the slot cap 1216. Conversely, to remove the slot cap 1216 from the bracket, the orthodontist may use the tweezers to grasp one of the detents 1264 and rotate the cross members 1212 according to arrow 1256 until the minor axis “w” spans the recess 1228, thus allowing the hinge 1208 slip or snap free of its recesses 1228 without exerting a force that might, e.g., damage the bracket, damage the bracket cap 1204, and/or harm or bruise the patient to which the bracket is affixed. Note that in an embodiment of the hinge 1208 having a circular cross section rather than the oval cross section shown in FIG. 14, properly configured sidewalls 1240, 1244, and closed end 1260 may be provided for contacting the hinge 1208 and providing friction for maintaining the slot cap 1216 in a closed position (where the slot cap covers the opening 1236), and maintaining the slot cap in an open position (where the slot cap does not cover the opening 1236). However, it may be very difficult to securely provide the hinge 1208 in its recesses 1228, and detach the hinge from its recesses since, e.g., the sidewalls 1240 and 1244 may have to be deformed by the diameter of the hinge, and this diameter must be sufficiently larger than the span of the recess 1228 to induce the substantial friction between the hinge and the surfaces of the recess to inhibit movement of the slot cap 1216.

Other shapes (e.g., cross sectional shapes) of the hinge are within the scope of the present disclosure. For example, the above advantages of the oval cross section may be provided by an egg shaped hinge cross section, or by providing a circular cross section wherein the diameter that would correspond to the

Instead of the one or more cap holders 1220 (or in addition to the cap holders), the placement/removal tab 1224 may used for positioning the bracket cap 1204 on its bracket, closing the slot cap 1216 over the opening 1236, and/or pivoting the slot cap away from the opening 1236. In particular, such a placement/removal tab 1224 may be grasped by orthodontic tweezers for performing such actions. Note that the placement/removal tab 1224 may provide an easier way to open and close the slot/channel opening 1236 since the tab 1224 can used to flip the bracket cap 1204 to the open position (where the slot cap does not cover the opening 1236), and/or flip the bracket cap 1204 to the closed position (where the slot cap covers the opening 1236). Moreover, such flipping may be performed without taking time to grasp the tab 1224 with orthodontic tweezers.

Embodiments of the bracket cap 1204 may used with the bracket 10 described hereinabove. However, embodiments of the bracket cap 1204 may also be used with brackets having twin tie wings on each of their gingival and occlusal sides. For such brackets, there may be a single cross member 1212 attached centrally along the length of the hinge 1208. Accordingly, when the bracket cap 1204 is in the closed position, the cross member 1212 extends across the gingival to occlusal recess extending between: the mesial pair of wings 20, and the distal pair of wings 20. However, the operation of the hinge 1208 when engaging the recesses 1228 between the bracket's base 1232 and each wing 20 of the gingival or occlusal pair is identical to the description provided hereinabove.

Even though the slot cap 1216 is typically intended to facilitate holding an archwire 16 in the archwire slot/channel 14 or 15, various embodiments of the slot cap 1216 may provided. For example, the mesial distal length of the slot cap 1216 may: (a) cover only a portion to the slot/channel (e.g., at least 10% of such length), (b) completely cover the slot/channel, or (c) extend past the mesial and/or distal edges of the bracket for an enhanced control of tooth movement. Depending on, e.g., (i) the extent to which the surface of the slot cap 1216 facing the slot/channel enters the opening 1236, and (ii) the texture and composition of this surface, various amounts of binding friction may be generated. In one preferred embodiment, this surface will not contact the archwire 16 in a manner that materially increases the binding friction.

In other embodiments, the cross section 1234 of the hinge 1208 may be polygonal shaped, and the concave shape of, e.g., the sidewall 1244 may have a mating polygonal shape so that the polygonal shaped portion of the cross section can mate at discrete positions between (and including): (a) the slot cap 1216 engaging and covering the opening 1236, and (b) the slot cap not occluding any portion of the opening 1236.

The bracket cap 1204 may be provided as a replacement for ligating bands in certain instances such as in an initial orthodontic treatment. In other instances, a ligating band 54 may be placed over a bracket cap 1204, thus further securing the cap to the bracket. That is, a bracket cap 1204 is first secured to a bracket, and then a ligating band 54 secured to the bracket/bracket cap combination. In this latter method of use, the bracket cap 1204 may be repeatedly attached and detached from a bracket (e.g., bracket 10). For example, in an initial orthodontic treatment, a ligating band may be placed on bracket 10 as shown in FIG. 4A, and then the bracket cap 1204 can be placed over the channel 15. Alternatively, the bracket cap 1204 may be attached to the bracket first and then the ligating band as in FIG. 4A can be attached. In subsequent orthodontic treatment sessions, the ligating band and the bracket cap 1204 can be removed (e.g., by rotating the cross member so that the hinge is relatively easily disengaged from the bracket recesses 1228), and the ligating band can be reconfigured to one of the other configurations shown in FIGS. 4B, through 4E. Moreover, the archwire shape may be reconfigured. The bracket cap 1204 can be once again attached to the bracket as described hereinabove, wherein the bracket cap may be attached either before or after the ligating band in its new configuration.

The present disclosure, in various embodiments, includes components, methods, processes, systems and/or apparatus substantially as depicted and described herein, including various embodiments, subcombinations, and subsets thereof. Those of ordinary skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The foregoing discussion of the disclosure has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An orthodontic appliance for attaching to a tooth, comprising:
a body having three tie wings on at least one of a gingival and occlusal side; a base for mating with a surface of the tooth, and an archwire receiving portion, wherein the receiving portion extends in a mesial-distal orientation in the body; and
a liner for the receiving portion, wherein the liner includes a floor and opposing sidewalls for lining the slot, wherein the sidewalls are flared at their mesial and distal ends at least 80% of a distance corresponding to a narrowest distance between the sidewalls, and the sidewalls are substantially parallel for at least one-quarter of a mesial-distal length of the liner;
wherein the liner reduces a friction with the archwire received therein in comparison to the archwire being received in the receiving portion without the liner,

2. The apparatus of claim 1, further including three tie wings on each of the gingival and occlusal sides.

3. The apparatus of claim 1, wherein a Knoop hardness of the liner is in a range of 10% to 30% of the Knoop hardness of the body.

4. The apparatus of claim 1, wherein at least one of the sidewalls extends from the floor to an opening of the receiving portion, wherein the opening extends between a mesial side of the body, and a distal side of the body.

5. The apparatus of claim 1, wherein the floor flares at its mesial and distal ends so that the sidewalls have a height that is at least 50% greater than another height of the sidewalls.

6. The apparatus of claim 1, further including indicia on the body for one or more of: identifying the bracket, and assisting in aligning the appliance on the tooth.

7. The apparatus of claim 1, wherein the base includes a side to which the tooth attaches, the side including a plurality of rails extending between the mesial and distal sides of the body, wherein the rails are wider at their ends than at their centers, and wherein interleaved with rails are channels, wherein at least one of the channels has a gingival-occlusal extent interior to the channel, the extent being greater than a corresponding opening for the channel, the opening being between the tooth and the extent when the bracket is attached to the tooth.

8. The apparatus of claim 1, wherein the liner includes gold.

9. The apparatus of claim 1, wherein the body includes a ceramic.

10. An apparatus for retaining an archwire used in a re-alignment of teeth, comprising:
an orthodontic appliance for attaching to a tooth, the orthodontic appliance having:
(a-1) at least one pair of adjacent tie wings on one of a gingival and occlusal side of the appliance;
(a-2) a base for mating with a surface of the tooth;
(a-3) a corresponding recess between the base and each of the adjacent tie wings; and
(a-4) an archwire receiving portion having an opening extending in a mesial-distal direction across the appliance;
a cap including:
(b-1) a hinge having a length sufficient for the hinge to contact the corresponding recesses of the adjacent tie wings;
(b-2) a cover for covering an opening extent that is at least 10% of the extent of the opening in the mesial-distal direction;
(b-3) a cross member having a length, wherein the hinge and the cover are attached to the cross member at spaced apart positions along the length;
wherein for at least one of the recesses, the hinge is in a first position relative to the at least one recess for entering the recess, the hinge is rotatable into a second position for securing the hinge in the at least one recess such that the cover provides access the opening extent, and the hinge is rotatable into a third position secured in the at least one recess such that the cover inhibits access to the opening extent;
wherein the hinge has:
(c-1) a first hinge dimension traverse to the length, wherein the first hinge dimension spans an opening to the at least one recess when the hinge is in the first position;
(c-2) a second hinge dimension traverse to the length, wherein the second hinge dimension corresponds to an extent of the hinge for securing the hinge in the at least one recess when the hinge is in the second position; and
(c-3) a third hinge dimension traverse to the length, wherein the third hinge dimension corresponds to an extent of the hinge for securing the hinge in the third position;
wherein the second hinge dimension is greater than the first and third dimensions.

11. The apparatus of claim 10, wherein the at least one recess includes opposing sides for contacting and retaining the hinge in the at least one recess.

12. The apparatus of claim 11, wherein the opposing sides are deformed when the hinge is in at least one of the second and third positions.

13. The apparatus of claim 12, wherein the opposing sides apply a pressure to the hinge for retaining the hinge in the at least one recess when the hinge is in at least one of the second and third positions.

14. The apparatus of claim 10, wherein between the second and third positions, the hinge and the at least one recess engage in a manner that moves the hinge to the third position.

15. The apparatus of claim 14, wherein a portion of the at least one recess is deformed by the hinge, and a deformation of the portion is reduced when the hinge moves from the second position to the third position.

16. The apparatus of claim 10, wherein a cross section of the hinge for determining each of the first, second and third dimensions has first and second cross sectional extents traverse to one another, wherein the first cross sectional extent is longer than the second cross sectional extent.

17. The apparatus of claim 16, wherein the second cross sectional extent is at least parallel with the first hinge dimension.

18. The apparatus of claim 17, wherein the second and third hinge dimensions are greater than the second cross sectional extent.

19. The apparatus of claim 10, wherein the at least one recess includes at least two of the recesses for receiving the hinge into the two recesses, each of the recesses provided between the base and a different one of the tie wings.

20. The apparatus of claim 19, wherein the at least one pair of adjacent tie wings includes three tie wings on the one of the gingival and occlusal side of the appliance.

21. The apparatus of claim 20, wherein the at least one recess includes three of the recesses aligned relative to one another for receiving the hinge so that the hinge concurrently moves between the first, second and third positions for each of the three recesses.

20. The apparatus of claim 19, wherein each of the two recesses includes a concave portion in which the hinge slides when moving between the second and third positions.

21. The apparatus of claim 10, further including a second cross member for connecting the hinge and the cover together along a length of the second cross member.

22. The apparatus of claim 21, wherein the length of the cross member and the second length of the second cross member have corresponding portions that are received within spaces between one of: (i) two tie wings, and (ii) a hook and a tie wing when the hinge is in the third position.

23. The apparatus of claim 22, wherein the spaces are on an opposite side of the appliance from the corresponding recesses.

24. The apparatus of claim 10, wherein the cap further includes at least one cap holder attached to the cross member, wherein the cover is attached along the length of the cross member between the hinge and the at least one cap holder, and wherein the at least one cap holder includes an expanded extent relative to a cross section of the length of the cross member, and the expanded extent includes a detent for being grasped by tweezers for moving the cap.

25. The apparatus of claim 24, wherein the at least one cap holder includes two cap holders.

26. The apparatus of claim 25, wherein a tab connects the two cap holders together.

27. The apparatus of claim 10, further including three tie wings on each of the gingival and occlusal sides of the appliance.

28. The apparatus of claim 10, wherein the archwire receiving portion has a liner with a Knoop hardness of the liner is in a range of 10% to 30% of the Knoop hardness of the base, wherein the liner includes a floor and opposing sidewalls for lining the slot, wherein the sidewalls are flared at their mesial and distal ends at least 10% of a distance corresponding to a narrowest distance between the sidewalls, and the sidewalls are substantially parallel for at least one-quarter of a mesial-distal length of the liner.

29. The apparatus of claim 28, wherein at least one of the sidewalls extends from the floor to an opening of the archwire receiving portion, wherein the opening extends between a mesial side of the base, and a distal side of the base.

30. The apparatus of claim 28, wherein the floor flares at its mesial and distal ends so that the sidewalls have a height that is at least 50% greater than another height of the sidewalls.

31. The apparatus of claim 10, further including indicia on the appliance for one or more of: identifying the bracket, and assisting in aligning the appliance on the tooth.

32. The apparatus of claim 10, wherein the base includes a side to which the tooth attaches, the side including a plurality of rails extending between the mesial and distal sides of the body, wherein the rails are wider at their ends than at their centers, and wherein interleaved with rails are channels, wherein at least one of the channels has a gingival-occlusal extent interior to the channel, the extent being greater than a corresponding opening for the channel, the opening being between the tooth and the extent when the bracket is attached to the tooth.

33. The apparatus of claim 10, the hinge contacts surfaces of the at least one recess on opposing sides of the hinge for exerting a friction for inhibiting the cover from moving from the third position.

34. The apparatus of claim 10, wherein the orthodontic appliance further includes:
a body having three tie wings on at least one of a gingival and occlusal side; a base for mating with a surface of the tooth, wherein the receiving portion extends in a mesial-distal orientation in the body; and
a liner for the archwire receiving portion, wherein the liner reduces a friction with the archwire in comparison to the body, wherein the liner includes a floor and opposing sidewalls for lining the archwire receiving portion.

35. A cover for an archwire receiving portion of an orthodontic appliance for attaching to a tooth, the orthodontic appliance having: (a) at least one pair of adjacent tie wings on one of a gingival and occlusal side of the appliance, (b) a base for mating with a surface of the tooth, (c) a corresponding recess between the base and each of the adjacent tie wings, and (d) an archwire receiving portion having an opening extending in a mesial-distal direction across the appliance, comprising:
a hinge having a length sufficient for the hinge to contact the corresponding recesses of the adjacent tie wings;
a cover for covering an opening extent that is at least 10% of the extent of the opening in the mesial-distal direction;
a cross member for attaching the hinge and the cover together;
wherein for at least one of the recesses, the hinge is in a first position relative to the at least one recess for entering the recess, the hinge is rotatable into a second position for securing the hinge in the at least one recess such that the cover provides access the opening extent, and the hinge is rotatable into a third position secured in the at least one recess such that the cover inhibits access to the opening extent;
wherein the hinge has:
(c-4) a first hinge dimension traverse to the length, wherein the first hinge dimension spans an opening to the at least one recess when the hinge is in the first position;
(c-5) a second hinge dimension traverse to the length, wherein the second hinge dimension corresponds to an extent of the hinge for securing the hinge in the at least one recess when the hinge is in the second position; and
(c-6) a third hinge dimension traverse to the length, wherein the third hinge dimension corresponds to an extent of the hinge for securing the hinge in the third position;
wherein the second hinge dimension is greater than the first and third dimensions.

36. A method for using an archwire for re-alignment of teeth, the method using:
an orthodontic appliance for attaching to a tooth, the orthodontic appliance having:
(a-1) three adjacent tie wings on each of a gingival and occlusal side of the appliance;
(a-2) a base for mating with a surface of the tooth;
(a-3) a corresponding recess between the base and each of the adjacent tie wings; and
(a-4) an archwire receiving portion having an opening extending in a mesial-distal direction across the appliance;
a cap including:
(b-1) a hinge having a length sufficient for the hinge to contact the corresponding recesses of the adjacent tie wings;
(b-2) a cover for covering an opening extent that is at least 10% of the extent of the opening in the mesial-distal direction;
(b-3) a cross member having a length, wherein the hinge and the cover are attached to the cross member at spaced apart positions along the length;
wherein for at least one of the recesses, the hinge is in a first position relative to the at least one recess for entering the recess, the hinge is rotatable into a second position for securing the hinge in the at least one recess such that the cover provides access the opening extent, and the hinge is rotatable into a third position secured in the at least one recess such that the cover inhibits access to the opening extent;
wherein the hinge has:
(c-7) a first hinge dimension traverse to the length, wherein the first hinge dimension spans an opening to the at least one recess when the hinge is in the first position;
(c-8) a second hinge dimension traverse to the length, wherein the second hinge dimension corresponds to an extent of the hinge for securing the hinge in the at least one recess when the hinge is in the second position; and
(c-9) a third hinge dimension traverse to the length, wherein the third hinge dimension corresponds to an extent of the hinge for securing the hinge in the third position;
wherein the second hinge dimension is greater than the first and third dimensions, comprising:
in a first orthodontic treatment, performing steps (d-1) and (d-2):
(d-1) providing a ligating band around only a center one of the wings on each side of the appliance;
(d-2) providing the hinge in the third position;
in a subsequent orthodontic treatment, performing steps (e-1) and (e-2):
(e-1) moving the hinge to the first position; and
(e-2) providing a ligating band around each non-center wing on each side of the appliance, wherein the ligating band forms a figure eight.

37. The method of claim 36, further including providing the hinge in the third position after performing the step (e-1).
